(19) United States
(12) Patent Application Publication
(10) Pub. No.: US 2014/0074961 A1
(43) Pub. Date: Mar. 13, 2014

(54) Efficiently Delivering Time-Shifted Media Content via Content Delivery Networks (CDNs)

(71) Applicants: Xiaomei Liu, Cupertino, CA (US); Lakshminarayanan Gunaseelan, Cupertino, CA (US)

(72) Inventors: Xiaomei Liu, Cupertino, CA (US); Lakshminarayanan Gunaseelan, Cupertino, CA (US)

(73) Assignee: FUTUREWEI TECHNOLOGIES, INC., Plano, TX (US)

(21) Appl. No.: 13/612,425

(22) Filed: Sep. 12, 2012

(51) Int. Cl. G06F 15/167

(52) U.S. Cl. 709/213

(57) ABSTRACT

Example embodiments herein provide for efficient distribution of content in a content distribution network (CDN) by a CDN server. The content is efficiently distributed by associating live content and time-shifted content with a common resource identifier, which may (in some instances) avoid re-transporting content across the network. To facilitate this, an entry point CDN server is configured to map the common resource identifier to a permanent storage location (that is itself associated with a different resource identifier) after expiration of the live viewing period.

### TECHNICAL FIELD

The present invention and disclosure relates generally to content delivery networks (CDNs), and more specifically for methods, systems, apparatuses, and computer program products designed and configured to efficiently deliver time-shifted media content therein.

### BACKGROUND

Content distribution networks (CDN) typically deploy a distributed system of servers in the data centers of a network (e.g., the Internet) for the purposes of serving content to end-users with high availability and performance. CDNs may provide a significant portion of Internet content today, including web objects (text, graphics, URLs and scripts), downloadable objects (media files, software, documents), applications (e-commerce, portals), live streaming media, on-demand streaming media, and social networks.

FIG. 1 illustrates a CDN 100 for distributing content from a source 102 to a plurality of users 151-155. As shown, the content is provided to a first CDN node (CDN node-1) 110 located in New York City (NYC). In this example, the source 102 may be providing any type of content, and may be accessed by various users 151-155 distributed throughout different parts of the country (or world). For instance, users 151-152 may be located in or around Dallas Fort Worth (DFW), user 153 located in NYC, and users 154-155 located in or around Los Angles (LA). As shown, the content may be provided to the users 151 and 152 by a second CDN node (CDN node-2) 120 located in DFW, and the user 154 and 155 by a third CDN node (CDN node-3) 130 located in LA. Notably, the content is stored locally in the CDN node-2 120 and CDN node-3 130 upon being initially accessed by the users 151 and 154, and thereafter is provided to the users 152 and 154 from local memory locations within the CDN node-2 120 and CDN node-3 130. Hence, one important advantage in CDNs is the ability to store content at distributed locations, thereby avoiding the re-transportation of content over the provider network.

### SUMMARY OF THE DISCLOSURE

Technical advantages are generally achieved, by aspects of this disclosure describing systems, methods, apparatuses, and/or computer program products for over the top (OTT) video network personal video recorder (PVR).

In accordance with an example embodiment, a method for efficiently distributing content in a content distribution network (CDN) by a CDN server is provided. In this example, the method includes storing the content in a temporary memory location in the CDN server during a live viewing period. The temporary memory location is associated with a first resource identifier. The method further includes forwarding the content from a temporary memory location to a first device in response to a first content request received from the first device during the live viewing period. The first content request specifies the first resource identifier. The method further comprises transferring the content from the temporary memory location to a permanent memory location of the CDN server after expiration of the live viewing period. The permanent memory location is associated with a second resource identifier. The method further comprises forwarding the content from the permanent memory location to a second device in response to a second content request received after expiration of the live viewing period. The second content request specifies the first resource identifier. An apparatus for performing the above method is also provided.

In accordance with another example embodiment, a CDN server for efficiently distributing content in a network is provided. In this example, the CDN server comprises a temporary memory location for storing the content during a live viewing period, a permanent memory location for storing the content after expiration of the live viewing period, and a control module. The temporary memory location is associated with a first resource identifier, and the permanent memory location is associated with a second resource identifier. The control module is configured to receive a content request specifying the first resource identifier from a device after expiration of the live viewing period; the content request specifying the first resource identifier; and forward the content from a permanent memory location to the device pursuant to receiving the content request. This effectively provides time-shifted content to a requesting user.

In accordance with yet another example embodiment, a content distribution network is provided. In this example, the content distribution network comprises an entry point CDN server and a remote CDN server. The entry point CDN server comprises a temporary storage location for storing content during a live viewing period and a permanent storage location for storing the content after expiration of the live viewing period. The temporary storage location is associated with a first resource identifier and the permanent storage location is associated with a second resource identifier that is different than the first resource identifier. The remote CDN server comprises a first memory location. The remote CDN server is configured to receive a first resource request specifying the first resource identifier from a first user during a live viewing period, forward the first resource request to the entry point CDN server, and receive content from the entry point CDN server in response to forwarding the first resource request. The remote CDN server is further configured to store the content in a first memory location, associate the first memory location with the first resource identifier, forward the content stored in the first memory location to the first user during the live viewing period. This effectively provides live content to the first user. The remote CDN server is further configured to receive a second resource request specifying the first resource identifier from a second user after expiration of the live viewing period, and forward the content stored in the first memory location to the second user. This effectively provides time-shifted content to the second user.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of a conventional CDN;

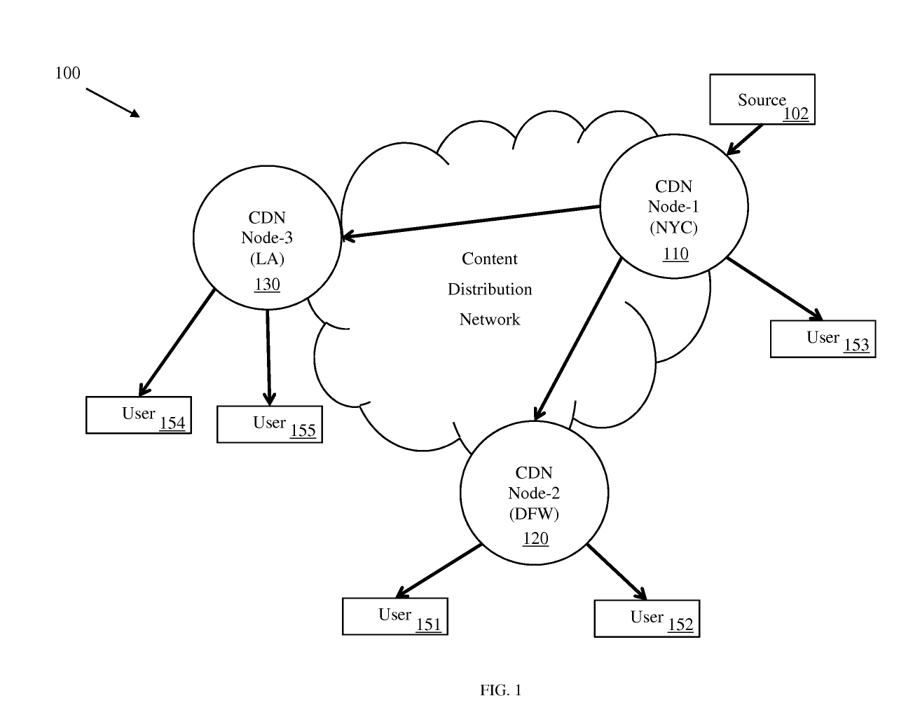

FIG. 2 illustrates a diagram of a prior art CDN for providing access to live and time-shifted versions of content to users;

FIG. 3 illustrates a protocol diagram of a prior art communications sequence for transporting live and time-shifted versions of content over the CDN depicted in FIG. 2;

FIG. 4 illustrates a diagram of an embodiment CDN for providing access to live and time-shifted versions of content to users;

FIG. 5 illustrates a protocol diagram of an embodiment communications sequence for transporting live and time-shifted versions of content over the embodiment CDN depicted in FIG. 4;

FIG. 6 illustrates a diagram of another embodiment CDN for providing access to live and time-shifted versions of content to users;

FIG. 7 illustrates a flowchart of an embodiment method for operating a content manager;

FIG. 8 illustrates a flowchart of an embodiment method for operating a content distribution node;

FIG. 9 illustrates a diagram of a yet another embodiment CDN for providing over-the-top (OTT) streaming video; and

FIG. 10 illustrates a block diagram of an embodiment of a content manager.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of example embodiments are discussed in detail below. It should be appreciated, however, that the present invention provides many applicable inventive concepts that can be embodied in a wide variety of more specific contexts. As such, the more specific embodiments discussed herein are merely illustrative of specific ways to make and use the invention; however, they are not meant to limit the scope of the invention unless otherwise claimed.

One popular service provided to end users of a CDN is on-demand access. For instance, live content (e.g., a concert, sporting event, etc.) may be recorded in an off-site location (e.g., a CDN server), and then accessed by the user in an on-demand fashion (e.g., at a time of the user's convenience). Hence, some users may access a live version of the content during a live viewing period, while other users may access a time-shifted version of the content after the live viewing period. As discussed herein, content accessed during the live viewing period may be referred to as live version of the content, while content accessed after the live viewing period may be referred to as time-shifted version of the content. Notably, both live and time-shifted versions of content generally consist of identical data and share a common bit-rate, and are consequently indistinguishable from the perspective of the user (although, different fee-structures/rates may be associated with the live and time-shifted versions of the content).

Live and time-shifted versions of the content are often stored in different types of storage locations of an entry point CDN server. For instance, a live version of content may be buffered in a temporary memory location of a CDN entry server, while a time-shifted version of the same content may be stored in a permanent memory location of the CDN entry server. In some embodiments, temporary memory may be volatile in nature, while permanent memory may be non-volatile in nature. Hence, buffering the live version of the content in temporary or volatile memory may allow for swifter processing of content requests during the live viewing period, during which such content requests are likely to be more frequent than after expiration of the live viewing period. On the other hand, storing time-shifted version of the content in permanent or non-volatile memory (e.g., ROM, etc.) may be cost-effective, as permanent or non-volatile memory may generally be less costly per unit of storage than volatile memory.

Notably, the temporary memory location is often associated with a different resource identifier (e.g., a uniform resource locator (URL), etc.) than the permanent memory location. Further, CDN nodes typically retrieve content based on the resource identifier specified by a content request, which causes live and time-shifted versions of the content to be transported separately over the CDN. In other words, because live and time-shifted versions of content are generally stored in locations that are associated with different resource identifiers, the time-shifted content is often needlessly re-transported over the CDN. This constitutes an inefficient utilization of the CDN's network resources (e.g., bandwidth, etc.), and therefore mechanisms for avoiding the re-transportation of content over the CDN are desired.

Aspects of this disclosure provide a mechanism to avoid duplicative re-transportation of the content over the CDN, thereby eliminating or reducing the traffic congestion in the CDN. Specifically, re-transportation of traffic is avoided by associating both live and time-shifted versions of the content with a common resource identifier, which prompts on-demand users to retrieve content from a local cache location of the serving CDN server (when possible), rather than from a permanent storage location of the entry point CDN server (which would require re-transportation of the content over the CDN).

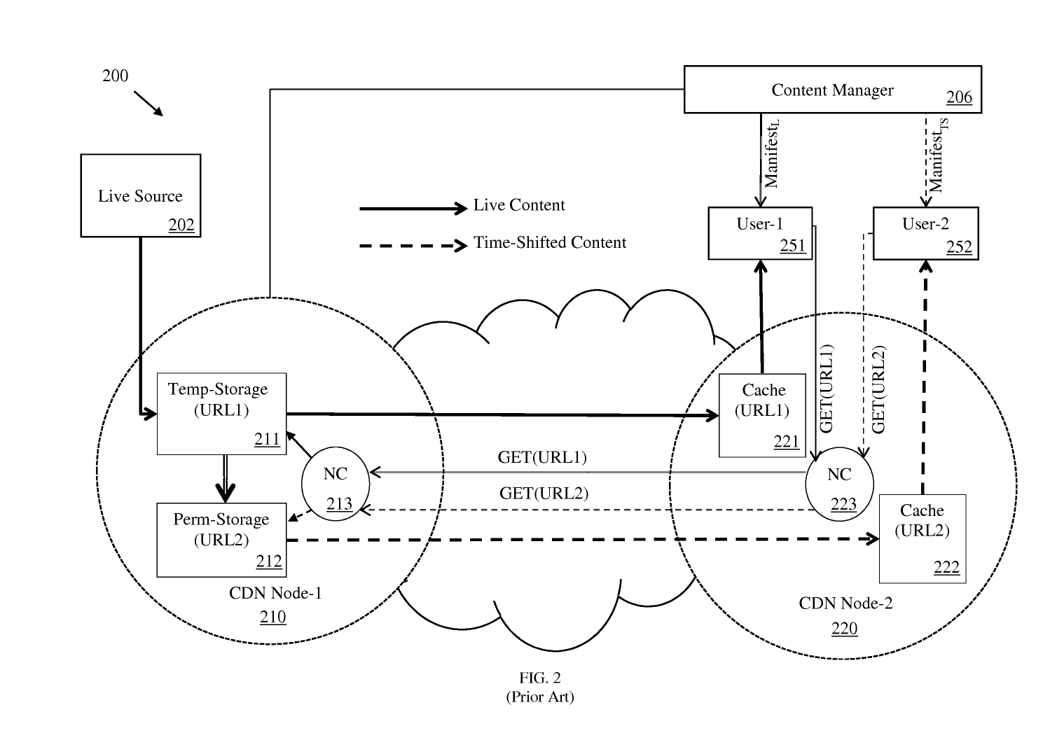

FIG. 2 illustrates a prior art CDN 200 for providing live and time-shifted versions of content to a plurality of users 251-252. As shown, the content originates from a live source 202, which forwards the content to a nearby CDN node-1 210 (e.g., in real time). The CDN node-1 210 serves as the entry point for the CDN 200, and buffers the content in a temporary storage location 211 during the live viewing period. Buffering the content in the temporary storage location 211 enables the CDN 200 to provide a playback service, which allows clients viewing the live version of the content (e.g., the user-1 251) to replay earlier portions of the live programing during the live viewing period. After the live viewing period expires, the CDN node-1 210 transfers the content from the temporary storage location 211 to a permanent storage location 212. Notably, the temporary storage location 211 is associated with a first resource identifier (e.g., URL-1) and permanent storage location 212 may be associated with a second resource identifier (e.g., URL-2), which is different than the URL-1.

The content manager 206 may be an internal or external CDN component that is responsible for, inter alia, distributing manifest files to potential users, such as the user-1 251 and the user-2 252. Manifest files associate content with resource identifiers, and are generally provided to users before they make content requests. Notably, content is typically retrieved from the CDN 200 in a transparent fashion, such that the users 251-252 are unaware of the location from which the content is retrieved.

The user-1 251 accesses the content during the live viewing period, while the user-2 252 accesses the content after expiration of the live viewing period. Specifically, the content manager 206 sends the user-1 251 a manifest file (Manifest_{L}) that associates the live version of the content with the URL-1 upon detecting an initialization of the user-1 251 during the live viewing period. As discussed herein, detecting an initialization of a user may refer to detecting any user activity, such as a user's selection of a channel, etc. Thereafter, the user-1 251 sends a content request specifying the URL-1 (GET(URL-1)) to the CDN node-2 220. For purposes of clarity and concision, content request messages may generally be referred to as GET messages, and resource identifiers may generally be referred to as URLs. However, other types of content request messages and/or resource identifiers may be used instead of GET messages and/or URLs (respectively) in some networks.

A node control (NC) module 223 within the CDN node-2 220 may receive and process the GET(URL-1) request. As discussed herein, NC modules may be any component of a CDN node (e.g., a central control processor (CPU), etc.) configured to perform CDN functions, such as fulfilling content request, communicating with other entities (e.g., content managers, other CDN nodes, users, etc.), storing content in storage/cache locations, transferring content from one storage/cache location to another, etc. In processing the GET(URL-1) request, the NC module 223 determines that none of the local cache locations 221-222 in the CDN node-2 220 are associated with the URL-1 (notably, the URL-1 is not associated with the cache 221 until later, after the live version of the content is forwarded from the CDN node-1). Thereafter, the NC module 223 identifies the CDN node-1 210 as the point of entry server for content associated with the URL-1, and forwards the GET(URL-1) message to the CDN node-1 210. An NC module 213 within the CDN node-1 210 receives and processes the GET(URL-1) request. In processing the GET(URL-1) request, the NC module 213 determines that the URL-1 is associated with the temporary storage location 211, and causes the content to be forwarded from the temporary storage location 211 to the CDN node-2 220. Upon reception at the CDN node-2 220, the content is stored in the local cache location 221, and the local cache location 221 is associated with the URL-1. This association allows the CN module 223 to satisfy future content requests specifying the URL-1 directly, by forwarding content from the local cache location 221 to a requesting user. The content is then forwarded to the user-1 251.

Upon expiration of the live viewing period, the CDN module 213 transfers the content from the temporary storage location 211 to the permanent storage location 212. Thereafter, the content manager 206 detects an initialization of the user-2 252, and sends a manifest file (Manifest_{TS}) associating the content with the URL-2 to the user-2 252. The user-2 252 then retrieves the content from the permanent storage location 212 of the CDN node-1 210 in much the same way as the user-1 252 retrieved the content from the temporary storage location 211. Specifically, the user-2 252 sends a GET message specifying the URL-2 (GET(URL-2) message) to the CDN node-2 220. Upon reception of the GET(URL-2) message, the NC module 223 determines that none of the local cache locations 221-222 in the CDN node-2 220 are associated with the URL-2, and forwards the GET(URL-2) message to the CDN node-1210. Accordingly, the CDN node-1 210 identifies the URL-2 as being associated with the permanent storage location 212, retrieves the content from the permanent storage location 212, and forwards the content to the CDN node-2 220. Upon receiving the content, the CDN node-2 220 stores the content in the local cache location 222, associates the local cache location 222 with the URL-2, and forwards the content to the user-2.

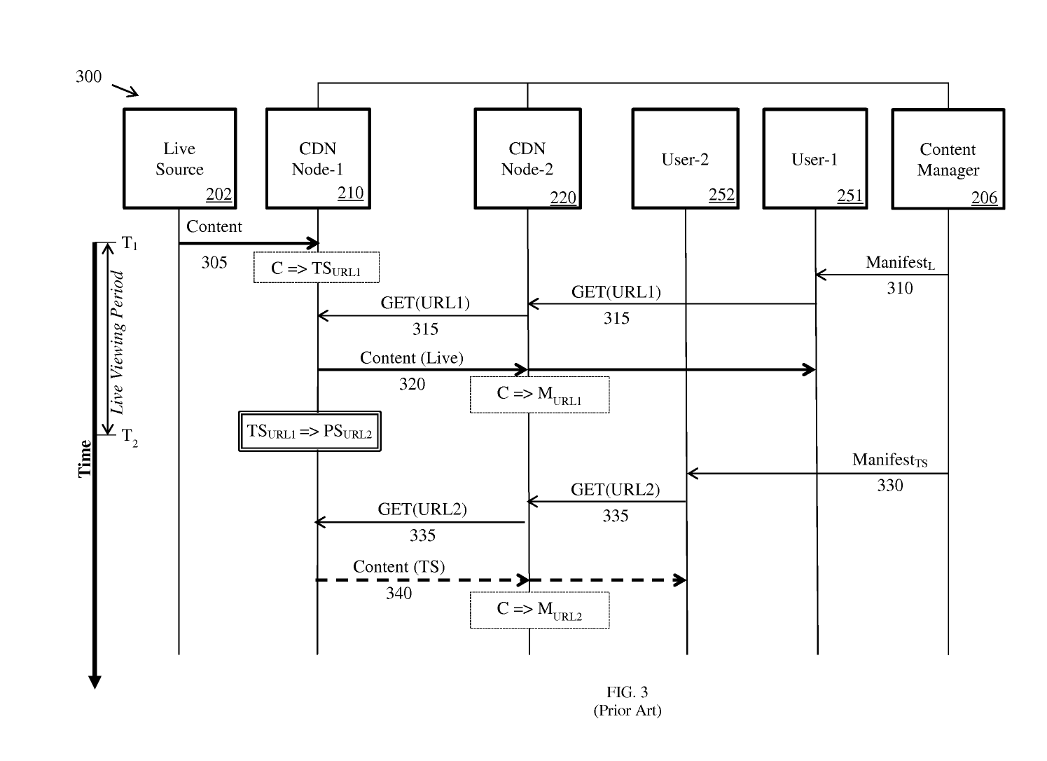

FIG. 3 illustrates a protocol diagram of a prior art communications sequence 300 for transporting the live and time-shifted versions of the content over the CDN 200. The prior art communications sequence 300 begins when the live source 202 communicates the content 305 to the CDN node-1 210 at a first period in time (T₁) (which designates the beginning of the live viewing period). Upon reception, the CDN node-1 210 buffers the content in a temporary storage location associated with URL-1 (C=>TS_{URL1}). Thereafter, the content manager 206 sends a first manifest file 310 to the user-1 251 associating the content with the URL-1. The user-1 251 then requests access to the live version of the content by sending a GET(URL-1) 315 to the CDN node-2 220, which forwards the GET(URL-1) to the CDN node-1 210. Upon reception of the GET(URL-1) 315, the CDN node-1 210 determines that the URL-1 is stored in the temporary storage location, and forwards the content 320 to the CDN node-2 220. Upon reception, the CDN-2 220 stores the content in a first local cache location, associates the first local cache location with the URL-1 (C=>M_{URL1}), and relays the live version of the content to the user-1 251.

The live viewing period expires at a second period in time (T₂), at which point the CDN node-1 210 transfers the content from the temporary storage location to a permanent storage location (TS_{URL1}=>PS_{URL2}). In some embodiments, the periods in which in the content is available as time-shifted version of the content and live version of the content may overlap. After the live viewing period has expired at T₂, the content manager 206 detects an initialization of the user-2 252, and sends a second manifest file 330 to the user-2 252. Thereafter, the user-2 252 sends a GET(URL-2) message 335 to the CDN node-2 220, which forwards the GET(URL-2) to the CDN node-1 210. Upon reception of the GET(URL-2) 335, the CDN node-1 210 forwards the content 340 to the CDN node-2 220. Thereafter, the CDN node-2 220 stores the time-shifted version of the content in a second local cache location, associates the second local cache location with the URL-2 (C=>M_{URL2}), and relays the time-shifted version of the content to the user-2 252.

As shown above in FIGS. 2-3, the time-shifted version of the content is re-transported across the CDN 200, which causes various inefficiencies (e.g., increased traffic congestion, etc.) in the network 200. Aspects of this disclosure address these inefficiencies by using a common resource identifier (e.g., UEL-1) to retrieve all versions of the content, thereby avoiding re-transportation of the content over CDN. Specifically and in accordance with aspects of this disclosure, manifests specify the common URL irrespective of which version of the content (e.g., live, time-shifted, or otherwise) the user is attempting to access, thereby prompting the user to specify the common URL in the content request. Prompting the on-demand user to request the content using the same URL as was used by the live user is achieved by sending the same manifest file to both users. Advantageously, this adaptation allows users to access time-shifted versions of the content from a local cache location, when the local cache location was used to store a live version of the content during the live viewing period, thereby avoiding re-transportation of the content over the CDN. Additionally, the entry point server is configured to map the common URL to the permanent storage location after expiration of the live viewing period. This allows the entry point server to fulfill content requests received after the live viewing period by forwarding content from the permanent storage location, even though these requests specify a URL associated with the temporary storage location (e.g., which is emptied after expiration of the live viewing period).

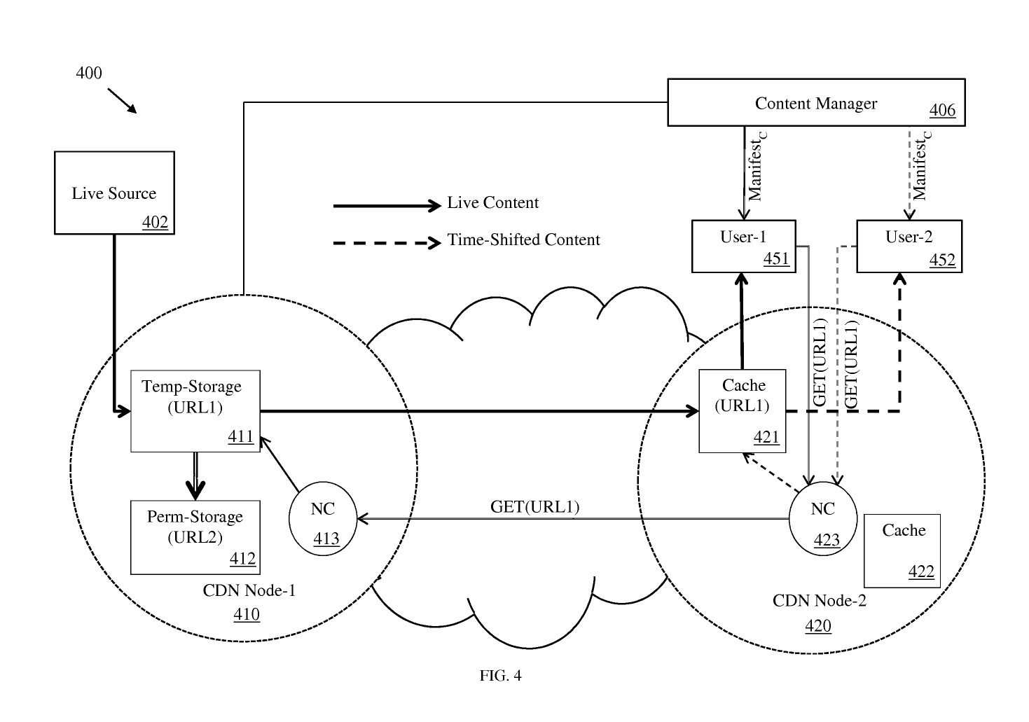

FIG. 4 illustrates a CDN 400 for providing access to live and time-shifted versions of content to a plurality of users 451-452. As shown, the content is forwarded from a live source 402 to the CDN node-1 410 in real time. The CDN node-1 410 serves as an entry point server for the content, and buffers the content in a temporary storage location 411 that is associated with a URL-1 during a live viewing period. Upon expiration of the live viewing period, the CDN node-1 410 transfers the content from the temporary storage 411 to a permanent storage location 412 associated with a URL-2.

The content manager 406 may be configured similarly to the content manager 206, and may be responsible for, inter alia, distributing manifest files to potential users, such as the user-1 451 and the user-2 452. However, unlike the content manager 206, the content manager 406 distributes a common manifest file (Manifest) to both the user-1 451 (during the live viewing period) and the user-2 452 (after the live viewing period). As a result, the user-2 452 will attempt specify the URL-1 when requesting the time-shifted content, for instance, by sending a GET(URL-1) message to the CDN node-2 420. Upon receiving the GET(URL-1), the NC module 423 will recognize that the URL-1 is associated with the local cache location 421, and will forward the content stored therein to the user-2 452. Hence, by sending a common manifest file to the both the user-1 451 and the user-2 452, the time-shifted version of the content is provided to the user-2 452 from the local cache location 422 of the remote CDN node-2 420, rather than the permanent storage location 412 of the CDN node-1 410. This avoids re-transporting the data over the CDN 400, thereby solving many of the network inefficiencies that are characteristic of the prior art CDN 200. Notably, the time-shifted and live versions of the content are in-distinguishable from the user's perspective, so the fact that the time-shifted version of the content is provided from the local cache location 421 (rather than the permanent storage location 412) is transparent to the user-2 452.

There are various techniques for ensuring that the first manifest file and the second manifest file associate the content with a common URL. For instance, the CDN node-1 410 may simply suppress (e.g., not communicate) the signaling indicating that the content was transferred to the permanent storage 412 at the end of the live viewing period. Or, the CDN node-1 410 may modify the signaling so that the content manager 406 associates the permanent storage location 412 with the URL-1, rather than the URL-2.

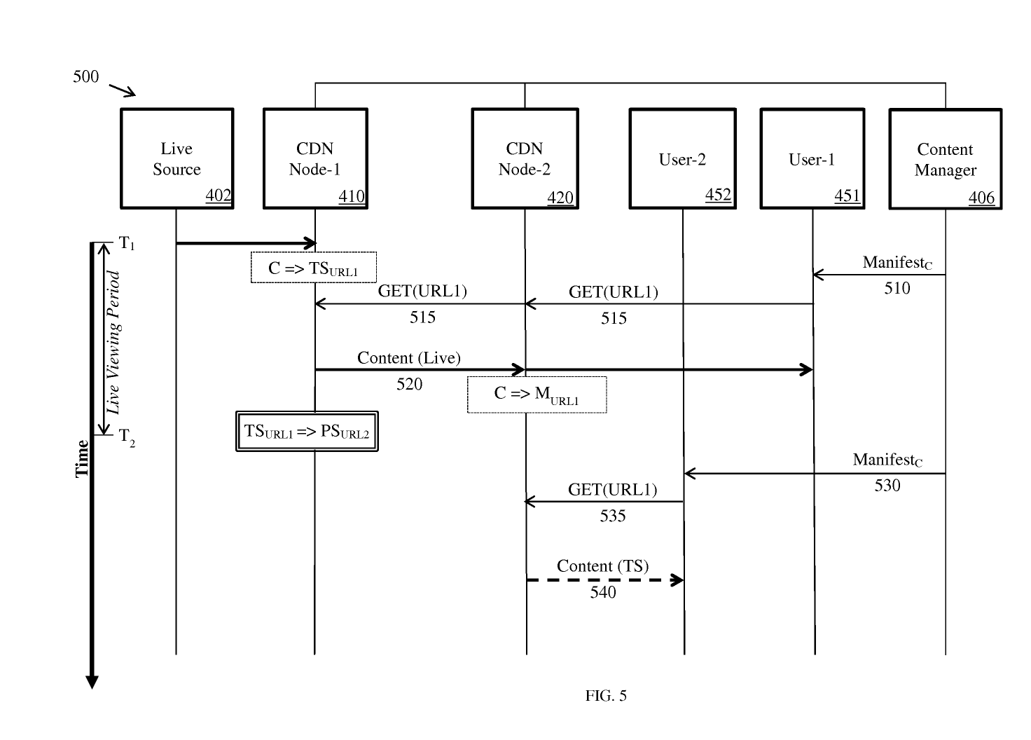

FIG. 5 illustrates a protocol diagram of a communications sequence 500 for providing the live and time-shifted versions of the content to the user-1 451 and user-2 452 (respectively) in the CDN 400. The messages 510-520 in the communications sequence 500 are similar, in many respects, to the messages 310-320 in the prior art communications sequence 300 in that they effectively allow the user-1 451 to access a live version of the content. Thereafter, the communications sequence 500 differs substantially from the prior art communications sequence 300. Specifically, the manifest 530 associates the time-shifted version of the content with the URL-1, rather than the URL-2, thereby prompting the content 540 to be retrieved from the local cache location in the CDN node-2 420 using a GET(URL-1) 535. Notably, the content provided to the user-2 452 may accurately be classified as time-shifted content, as the content is accessed by the user-2 452 after the live viewing period.

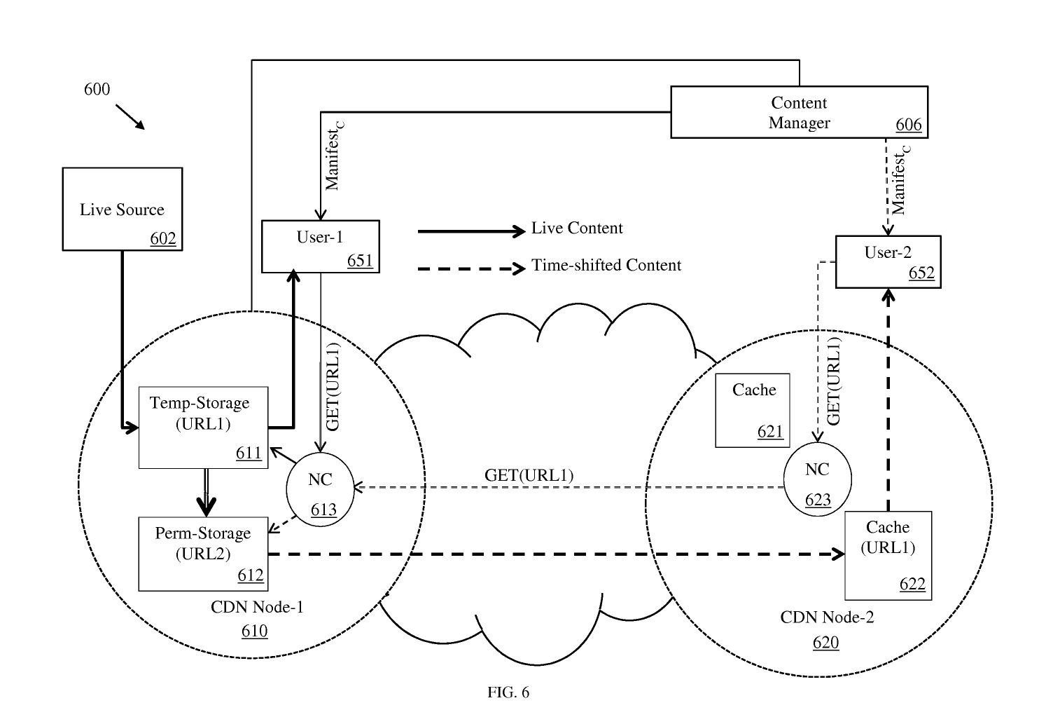

Markedly, the second manifest file (sent after expiration of the live viewing period) may associate the content with the URL-1 irrespective of whether a live version of the content was transported to, and stored in, the remote CDN server during the live viewing period. As such, the entry point CDN server should be configured to map the URL-1 to the permanent storage location (which is associated with the URL-2). This concept is better understood with reference to FIG. 6, which illustrates a CDN 600 for delivering content to a plurality of users 651-652. The CDN 600 may comprise a live source 602, a content manager 606, a CDN node-1 610, and a CDN node-2 620, which may be configured similarly to like devices in the CDN 400. However, unlike the CDN 400, the live version of the content is not transported to the CDN node-2 during the live viewing period. Instead, the user 651 retrieves the content from the CDN node-1 610 during the live viewing period, and consequently the content is not stored in the local cache location 621 of the CDN node-2 620 during the live viewing period. Nevertheless, the content manager 606 associates the time-shifted version of the content with the URL-1 in the second manifest file sent to the user-2 652 after expiration of the live viewing period. As a result, the user-2 652 specifies the URL-1 when requesting the time-shifted content, for instance, by sending a GET(URL-1) message, which is eventually forwarded to the NC module 613.

Notably the NC module 613 receives the GET(URL-1) message after the live viewing period, at which point the content has been moved from the temporary storage 611 (associated with the URL-1) to the permanent storage location 612 (associated with the URL-2). To account for this, the NC module 613 is configured to map the URL-1 to the URL-2 (or otherwise, to the permanent storage location 612) after expiration of the live viewing period, thereby allowing the content to be forwarded from the permanent storage location 612 to the CDN node-2 620. The CDN node-2 620 (e.g., at the direction of the NC module 623) stores the content in the local cache location 622, and associates the local cache location 622 with the URL-1 (which was the URL specified by the user-2 in the content request message). Notably, mapping of the URL-1 to the URL-2 by the NC module 613 is transparent to the CDN node-2 620, and therefore the local cache location 622 is associated with the URL-1 (as specified by the user), not the URL-2 (as associated with the permanent storage location 612). Thereafter, the content is forwarded to the user-2 652.

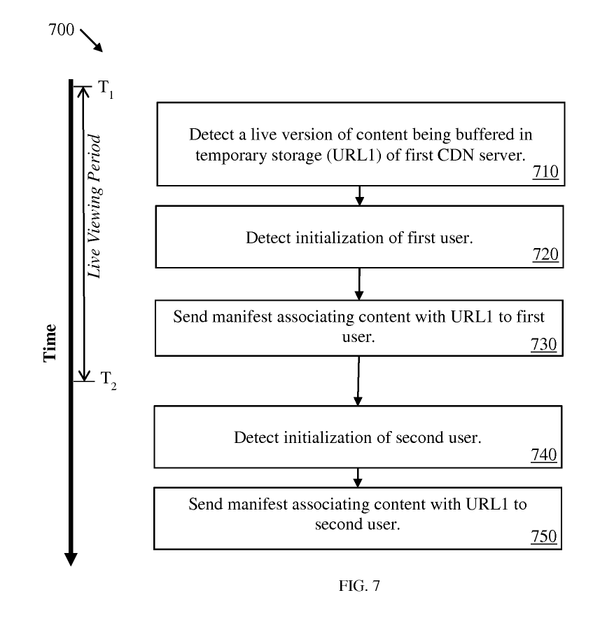

FIG. 7 illustrates a method 700 for operating a content manager. The method 700 begins at step 710, where the content manager detects that a live version of content is buffered in a temporary storage location associated with a URL-1 of a first CDN server. Next, the method 700 proceeds to step 720, where the content manager detects initialization of a first user (e.g., user-1 451). Thereafter, the method 700 proceeds to step 730, where the content manager sends a first manifest file associating the content with URL-1 to the first user. After the live viewing period expires (at T₂), the method 700 proceeds to step 740, where the content manager detects initialization of a second user. Thereafter, the method 700 proceeds to the step 750, where the content manager sends a second manifest file associating the content with URL-1 to the second user. Notably, the first and second manifests are identical.

Notably, URLs are constantly being appended to the manifest file during the live viewing period as a result of fragmentation during adaptive bit-rate streaming. To wit, the manifest file may typically comprise a sequence of URLs, with each URL corresponding to a memory section storing a few seconds of fragmented content. Hence, while live content is being ingested at the entry point node during the live viewing period (e.g., during the live event), new URLs corresponding to each new fragment are constantly being appended to the manifest file. At the end of the live event, the manifest file stabilizes. According to aspects of this disclosure, the manifest file remains unchanged during the time-shifted viewing period, such that the URLs in the manifest file are not altered. Comparatively, conventional systems generate a new manifest file upon transferring the content from the temporary storage location to the new storage location. For instance, assume that the manifest file at the end of the viewing period comprises a plurality of URLs (e.g., URL11, URL12, URL13 . . . URL1N (where N is an integer)) corresponding to the temporary storage location. In conventional networks, the URLs in the manifest file (e.g., URL11, URL12, URL13 . . . URL1N) would be modified (e.g., URL21, URL22, URL23, . . . URL2N) at the end of the live viewing period to reflect that the content is transferred from the temporary storage location to the permanent storage location. In networks operating in accordance with one or more aspects of this disclosure, the URLs in the live manifest file would remain unchanged, such that time-shifted users would be sent a manifest file comprising URLs to those sent to the live user, and the entry point CDN server would map the original URLs (e.g., associated with the temporary memory location) to the permanent memory location (e.g., URL11=>URL21; URL12=>URL22; URL13=>URL23; . . . URL1N=>URL2N).

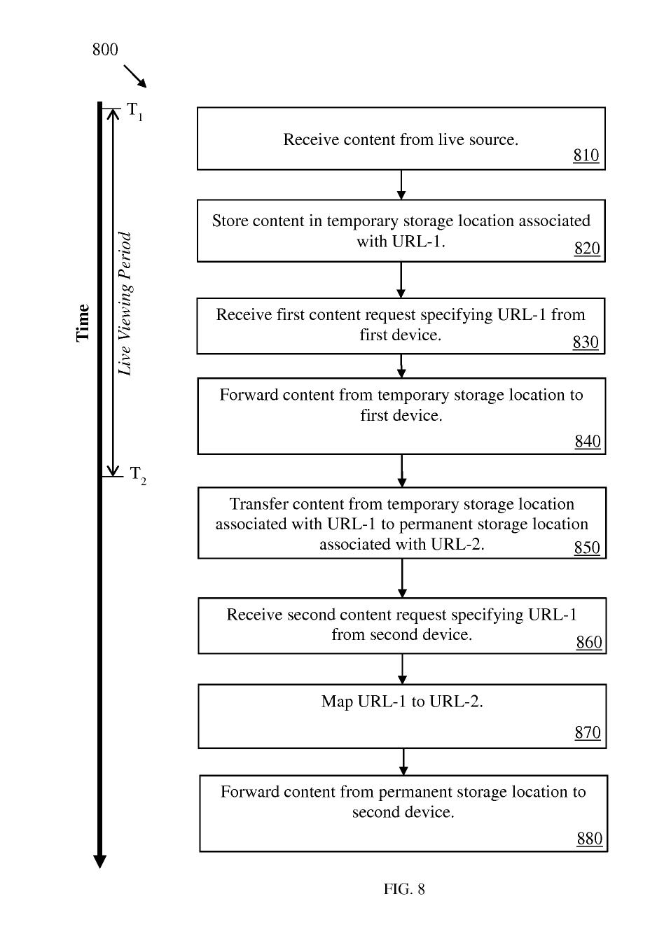

FIG. 8 illustrates a flowchart of a method 800 for operating an entry point CDN server. The method 800 begins at step 810, where the entry point CDN server begins receiving content from a live source, marking the start of the live viewing period. Next, the method 800 proceeds to step 820, where the entry point CDN server stores the live version of the content in a temporary storage location associated with URL-1. Next, the method 800 proceeds to step 830, where the entry point CDN server receives a content request specifying the URL-1 from a first device. Thereafter, the method 800 proceeds to step 840, where the entry point CDN server forwards the content from the temporary storage location to the first device. After expiration of the live viewing period (at T₂), the method 800 proceeds to the step 850, where the entry point CDN server transfers the content from the temporary storage location (associated with the URL-1) to a permanent storage location (associated with the URL-2). Next, the method 800 proceeds to step 860, where the entry point CDN server receives a second content request specifying the URL-1 from a second device. Thereafter, the method 800 proceeds to step 870, where the entry point CDN server maps the URL-1 (in the second content request) to the URL-2 (associated with the permanent storage location). Thereafter, the method 800 proceeds to step 880, where the entry point CDN server forwards the content from the permanent storage location to the second device.

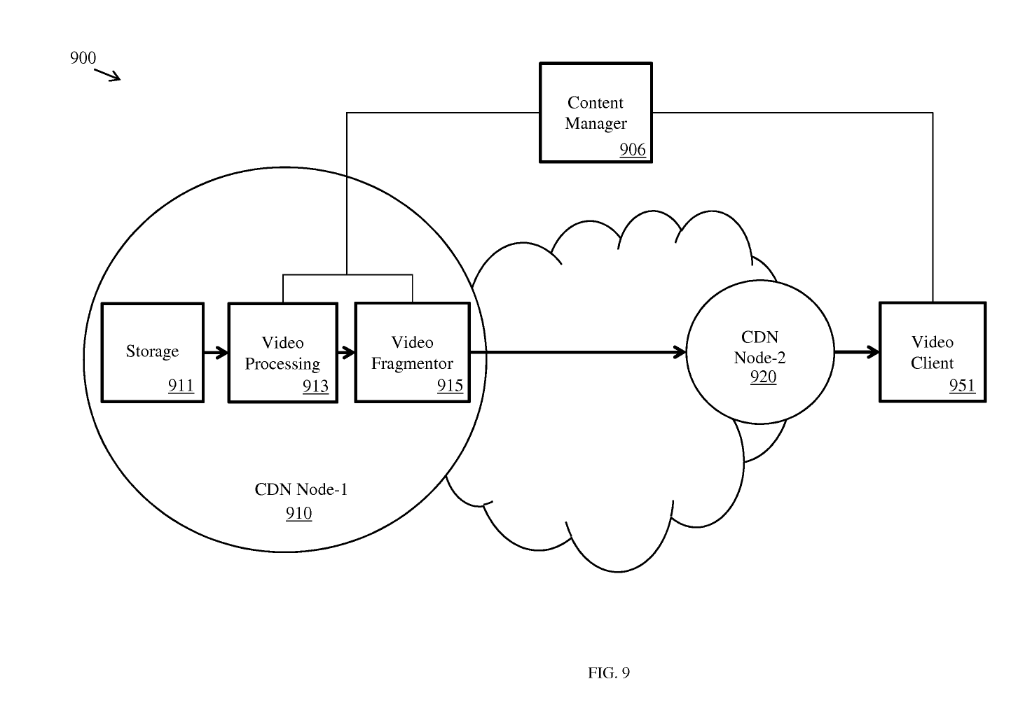

In some embodiments, the content may be provided in an over the top (OTT) manner, which is a technique for streaming video over a Transport Control Protocol (TCP) connection of an IP provider network. OTT streaming may be include (for instance) Hypertext Transfer Protocol (HTTP) adaptive streaming, which allows the client to vary the bit-rate depending on channel conditions. FIG. 9 illustrates a CDN 900 for providing OTT streaming video. As shown, the CDN 900 streams the video content from a CDN node-1 910 (which serves as the entry point for the content) to a video client 951 served by a CDN node-2 920. The CDN 900 includes a content manager 906, which facilitates the OTT streaming by providing the client with the URLs associated with the content. The CDN node-1 910 includes a storage location 911 (e.g., temporary, permanent, or otherwise), a video processing module 913, and a video fragmentor 915. The storage location 911 may provide the content to a video processing module 913 (e.g., in response to a content request or GET message). The video processing module 913 may be any component that is capable of encoding the video media using various bit-rates. In one embodiment, the content manager 906 may be configured to encode the content using multiple bitrates, each of which may be associated with a different URL. Hence, content encoded using first bit-rate (e.g., 500 megabits-per-second (Mb/s)) may be associated with a different URL that the same content encoded using a second bit-rate (e.g., one gigabit-per-second (1 Gb/s). The video fragmentor 915 may be any component that is capable of fragmenting the encoded video content into small pieces (e.g., 2-10 seconds in length), the length of which may (in some implementations) depend on the bit-rate selected by the video client 951.

The video client 951 may have the ability to switch the bitrate at the CDN entry location (i.e., the CDN node-1 910) to adapt to the current condition of the CDN 900. For instance, the video client 951 may obtain a manifest file from the content manager 906 which contains detailed information for video fragment access (e.g., URLs associated with different bit-rates of content, etc.). After obtaining the manifest file, the video client may send one or more GET messages specifying the URL of the requested content. This technique may be referred to as bandwidth adaptation, and may allow the video client 951 to choose a higher bitrate video (i.e., higher quality level) when the network condition is good and choose a lower bitrate video (i.e., lower quality level) when the network condition is bad. Beyond the bandwidth adaptation, the HTTP video streaming also has benefit of CDN scaling, which may allow the streaming video to be scaled with a simple Internet CDN without imposing any special requirement on the CDN.

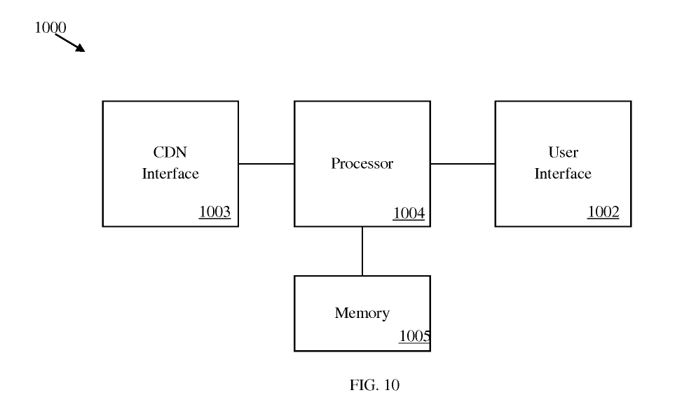

FIG. 10 illustrates a block diagram of an embodiment of a control manager 1000, as may be deployed for executing aspects of this disclosure. The control manager 1000 may include a user interface 1002, a CDN interface 1003, a processor 1004, and a memory 1005, which may (or may not) be arranged as shown in FIG. 10. The user interface 1002 may be any component or collection of components that allows the control manager 1000 to communicate with a user, and may be used to receive and/or transmit information over a control channel extending between the control manager and one or more users. The CDN interface 1003 may be any component or collection of components that allows the control manager 1000 to communicate with a CDN component (e.g., a CDN server, etc.), and may be used to receive and/or transmit information over a control channel extending between the control manager and one or more CDN servers. The processor 1004 may be any component capable of performing computations and/or other processing related tasks, and the memory 1005 may be any component capable of storing programming and/or instructions for the processor 1004.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for delivering both live and time-shifted content using the same resource identifier to avoid re-transporting the time-shifted content across a content distribution network (CDN), the method comprising:
storing content in a temporary memory location in a CDN server during a live viewing period, the temporary memory location being associated with a first resource identifier;
forwarding the content from the temporary memory location to a first device in response to a first content request received from the first device during the live viewing period, the first content request specifying the first resource identifier;
transferring the content from the temporary memory location to a permanent memory location of the CDN server after expiration of the live viewing period, the permanent memory location being associated with a second resource identifier; and
forwarding the content from the permanent memory location to a second device in response to a second content request received after expiration of the live viewing period, the second content request specifying the first resource identifier.

2. The method of claim 1, wherein the first resource identifier is different than the second resource identifier.

3. The method of claim 1, wherein the first resource identifier comprises a first uniform resource locator (URL), and wherein the second resource identifier comprises a second URL that is different than the first URL.

4. The method of claim 1 further comprising mapping the first resource identifier to the second resource identifier before forwarding the content from the permanent memory location to the second device.

5. The method of claim 1, wherein the temporary storage location comprises volatile memory, and wherein the permanent storage comprises non-volatile memory.

6. A computer program product having a non-transitory computer readable medium with computer executable code stored thereon that, when executed, delivers both live and time-shifted content using a common resource identifier to avoid re-transporting the time-shifted content across a Content Distributed Network (CDN), the computer executable code including instructions for:
storing content in a temporary memory location of a CDN server during a live viewing period, the temporary memory location being associated with a first resource identifier;
forwarding the content from the temporary memory location to a first device in response to a first content request received from the first device during the live viewing period, the first content request specifying the first resource identifier;
transferring the content from the temporary memory location to a permanent memory location of the CDN server after expiration of the live viewing period, the permanent memory location being associated with a second resource identifier; and
forwarding the content from the permanent memory location to a second device in response to a second content request received after expiration of the live viewing period, the second content request specifying the first resource identifier.

7. The computer program product of claim 6, wherein the first resource identifier is different than the second resource identifier.

8. The computer program product of claim 6, wherein the first resource identifier comprises a first uniform resource locator (URL), and wherein the second resource identifier comprises a second URL that is different than the first URL.

9. The computer program product of claim 6, wherein the non-transitory computer readable medium further comprises code for mapping the first resource identifier to the second resource identifier before forwarding the content from the permanent memory location to the second device.

10. The computer program product of claim 6, wherein the temporary storage location comprises volatile memory, and wherein the permanent storage comprises non-volatile memory.

11. A content distribution network (CDN) server for delivering both live and time-shifted content using a common resource identifier to avoid re-transporting the time-shifted content across a CDN, the CDN server comprising:
a temporary memory location for storing the content during a live viewing period, the temporary memory location being associated with a first resource identifier;
a permanent memory location for storing the content after expiration of the live viewing period, the permanent memory location being associated with a second resource identifier; and
a control module configured to:
receive a content request from a device after expiration of the live viewing period, the content request specifying the first resource identifier; and
pursuant to receiving the content request, forward the content from the permanent memory location to the device, thereby providing a time-shifted version of the content to a requesting user associated with the device.

12. The CDN server of claim 11, wherein the first resource identifier is different than the second resource identifier.

13. The CDN server of claim 11, wherein the first resource identifier comprises a first uniform resource locator (URL), and wherein the second resource identifier comprises a second URL that is different than the first URL.

14. The CDN server of claim 11, wherein the control module is further configured to map the first resource identifier to the second resource identifier before forwarding the content from the permanent memory location to the device.

15. A content distribution network (CDN) for delivering both live and time-shifted content using the same resource identifier to avoid re-transporting the time-shifted content across the CDN, the CDN comprising:
an entry point CDN server comprising a temporary storage location for storing content during a live viewing period and a permanent storage location for storing the content after expiration of the live viewing period, wherein the temporary storage location is associated with a first resource identifier and the permanent storage location is associated with a second resource identifier that is different than the first resource identifier;
a remote CDN server comprising a first memory location, the remote CDN server configured to:
receive a first resource request from a first user during a live viewing period, the first resource request specifying the first resource identifier;
forward the first resource request to the entry point CDN server;
receive content from the entry point CDN server in response to forwarding the first resource request;
store the content in a first memory location and associate the first memory location with the first resource identifier;
forward the content stored in the first memory location to the first user during the live viewing period, thereby providing a live version of the content to the first user;
receive a second resource request from a second user after expiration of the live viewing period, the second resource request specifying the first resource identifier; and
forward the content stored in the first memory location to the second user, thereby providing a time-shifted version of the content to the second user.

16. The CDN of claim 15 further comprising:
a content manager configured to send a first manifest file to the first user during the live viewing period and send a second manifest file to the second user after expiration of the live viewing period, wherein both the first manifest file and the second manifest file associate the content with the first resource identifier.

17. The CDN of claim 15, wherein the remote CDN server provides the time-shifted version of the content to the second user without accessing the permanent storage location.

18. The CDN of claim 15, wherein the first resource identifier comprises a first uniform resource locator (URL), and wherein the second resource identifier comprises a second URL that is different from the first URL.

19. The CDN of claim 15, wherein the time-shifted version of the content and the live version of the content comprise identical data streams.

20. The CDN of claim 15, wherein the time-shifted version of the content and the live version of the content share a common bit-rate.

21. The CDN of claim 15, wherein in the temporary storage location comprises volatile memory, and wherein the permanent storage comprises non-volatile memory.
